(19) United States
(12) Patent Application Publication
(10) Pub. No.: US 2004/0110481 A1
(43) Pub. Date: Jun. 10, 2004

(54) Antenna and wireless device utilizing the antenna

(76) Inventor: Umesh Navsariwala, Schaumburg, IL (US)

Correspondence Address: TOLER & LARSON & ABEL L.L.P., 5000 PLAZA ON THE LAKE STE 265, AUSTIN, TX, 78746, US

(21) Appl. No.: 10/314,407

(22) Filed: Dec. 7, 2002

(51) Int. Cl. H04B 1/00; H04B 1/06; H04B 7/00

(52) U.S. Cl. 455/269; 455/129

(57) ABSTRACT

An antenna that includes a radiating element and a feed capacitor element is disclosed. The radiating element is at least substantially balanced and the feed capacitor element is capacitively coupled to the radiating element. Also disclosed is a wireless device that utilizes an inverted C-type antenna.

### FIELD OF THE DISCLOSURE

The present invention relates generally to antenna design and wireless devices that utilize the antenna.

### BACKGROUND

Many commercially available wireless devices are being developed for a variety of applications such as personal digital assistants, cellular phones and gaming devices. Such wireless devices have an antenna to receive and transmit wireless signals. With handheld devices, low power and space constraints are at a premium, and affect the design of the antenna for such wireless devices. In many applications, balanced antennas, such as dipoles and loops, are preferred over unbalanced types of antennas, like monopoles and inverted-F antennas, due to considerations of power, matching to radio frequency components, and sensitivity to the environment. However, conventional balanced antennas require a large amount of board space in the communication device. It would be desirable to have an improved antenna design with reduced space requirements.

Accordingly, there is a need for an improved antenna design and a need for new wireless devices that utilize an improved antenna.

### BRIEF DESCRIPTION OF THE DRAWINGS

FIG. 1 is a general diagram that illustrates a particular embodiment of an antenna integrated on a printed circuit board.

FIG. 2 is a general diagram that illustrates another particular embodiment of an antenna.

FIG. 3 is a top view of another embodiment of an antenna.

FIG. 4 is a side view that further illustrates the particular embodiment of the antenna shown in FIG. 3.

FIG. 5 is a side view that illustrates a particular simplified embodiment of an antenna with marked dimensions.

FIG. 6 is a general diagram that illustrates an embodiment of a wireless device that utilizes an inverted C-type antenna.

FIGS. 7-9 are general diagrams that illustrate different views of a radiation pattern of an inverted C-type antenna.

FIG. 10 is a flow chart that illustrates a method of receiving and processing wireless signals at a wireless device that utilizes an inverted C-type antenna.

FIG. 11 is a flow chart that illustrates a method of processing user input and transmitting wireless signals at a wireless device that utilizes an inverted C-type antenna.

### DETAILED DESCRIPTION OF THE FIGURES

The present disclosure is generally directed to an antenna, a wireless device with an antenna, and a method relating thereto. In a particular embodiment, the antenna includes a radiating element that is substantially balanced and a feed capacitor element that is capacitively coupled to the radiating element.

In another embodiment, the wireless device includes an inverted C-type antenna and a radio frequency module coupled to the inverted C-type antenna. In a further embodiment, a method of processing a wireless signal at a wireless device includes receiving the wireless signal at an inverted C-type antenna coupled to the wireless device.

Referring to FIG. 1, an inverted C-type antenna 100 integrated on a printed circuit board is illustrated. The inverted C-type antenna 100 includes a radiating element 120, a center portion 115, a first transmission line 111, and a second transmission line 112. The inverted C-type antenna 100 further includes a first capacitive load element 105 and a second capacitive load element 106. The first capacitive load element 105 is capacitively coupled to the ground plane 101. Similarly, the second capacitive load element 106 is capacitively coupled to the ground plane 101. The radiating element 120 is coupled to the first capacitive load element 105 via a first segment 122 at one end and is coupled to the second capacitive load element 106 via a second segment 124 at the other end. The radiating element 120 together with the first segment 122 and the second segment 124 forms an inverted C-type shape.

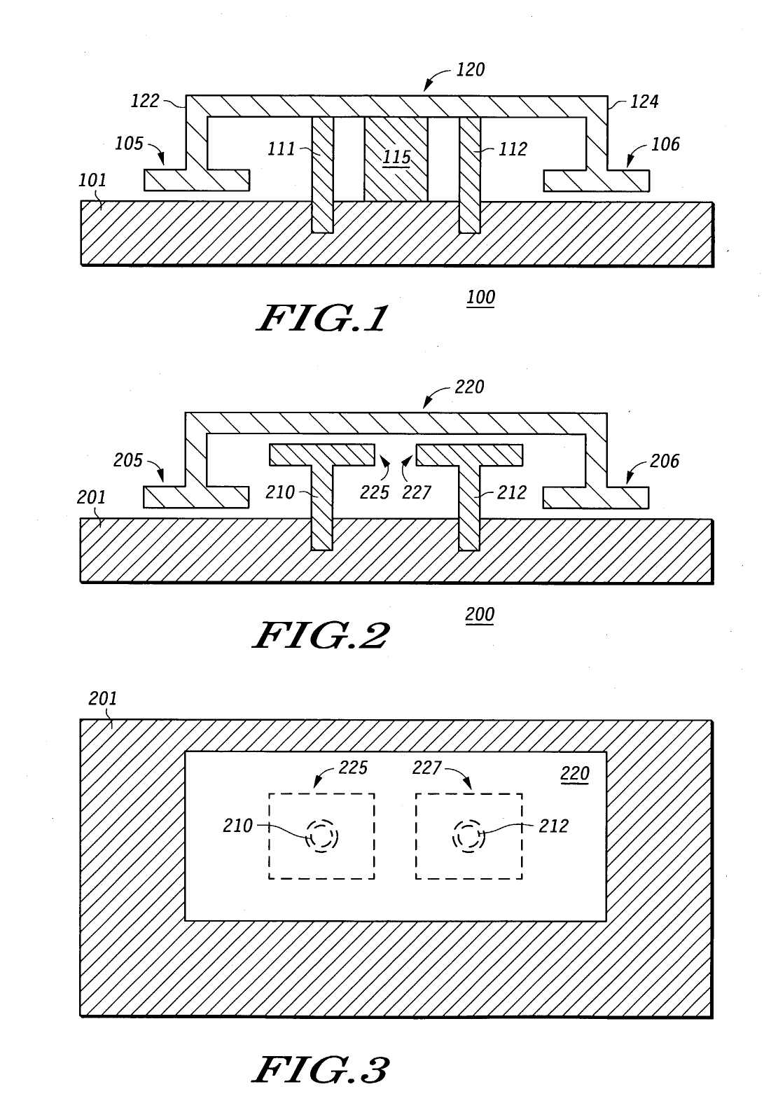

Referring to FIG. 2, another illustrative embodiment of an inverted C-type antenna 200 is shown. The inverted C-type antenna 200 includes radiating element 220, capacitive load elements 205 and 206, and transmission line elements 210 and 212. The inverted C-type antenna 200 also includes a first capacitive feed element 225 and a second capacitive feed element 227. The first and second capacitive feed elements 225 and 227 are each proximate to (e.g. within two millimeters of separation) and capacitively coupled to the radiating element 220. In addition, the first capacitive feed element is coupled to the first transmission line 210 and the second capacitive feed element 227 is coupled to the second transmission line 212. The transmission lines 210 and 212 form a balanced transmission line that is connected to radio frequency circuitry.

While the inverted C-type antenna 200 does not include a center ground connection, such center ground connection is optional and may or may not be attached depending upon the particular antenna application and size constraint requirements. Use of the feed capacitor elements 225 and 227 advantageously provides for an antenna structure with reduced space requirements. The inverted C-type antenna 200 may be integrated onto a printed circuit board that includes circuitry, such as circuitry associated with a radio frequency module.

Referring to FIG. 3, a planar version of an inverted C-type antenna is shown. FIG. 3 shows a top view of a particular illustrative inverted C-type antenna implementation. The inverted C-type antenna includes the first and second capacitive feed elements 225 and 227, the first and second transmission lines 210 and 212, and the balanced radiating element 220. Also shown, are the ground plane 201 and the first and second transmission lines 210 and 212, respectively, which are connected to radio frequency circuitry. The radiating element 220 is at least substantially balanced to provide for improved radiating performance. In a particular illustrative embodiment, a first signal communicated over the first transmission line 210 is out of phase, preferably 180 degrees out of phase, from a second signal carried over the second transmission line 212. In a particular example, due to the out of phase relationship of the first and second signals carried by the two transmission lines, the radiating element 220 would be balanced. In alternative implementations, the first and second signals over the first and second transmission lines may have a phase relationship other than exactly 180 degrees. In another particular example, the first and second transmissions line signals may be out of phase from 450 degrees to 210 degrees. In this scenario, the radiating element is at least substantially balanced.

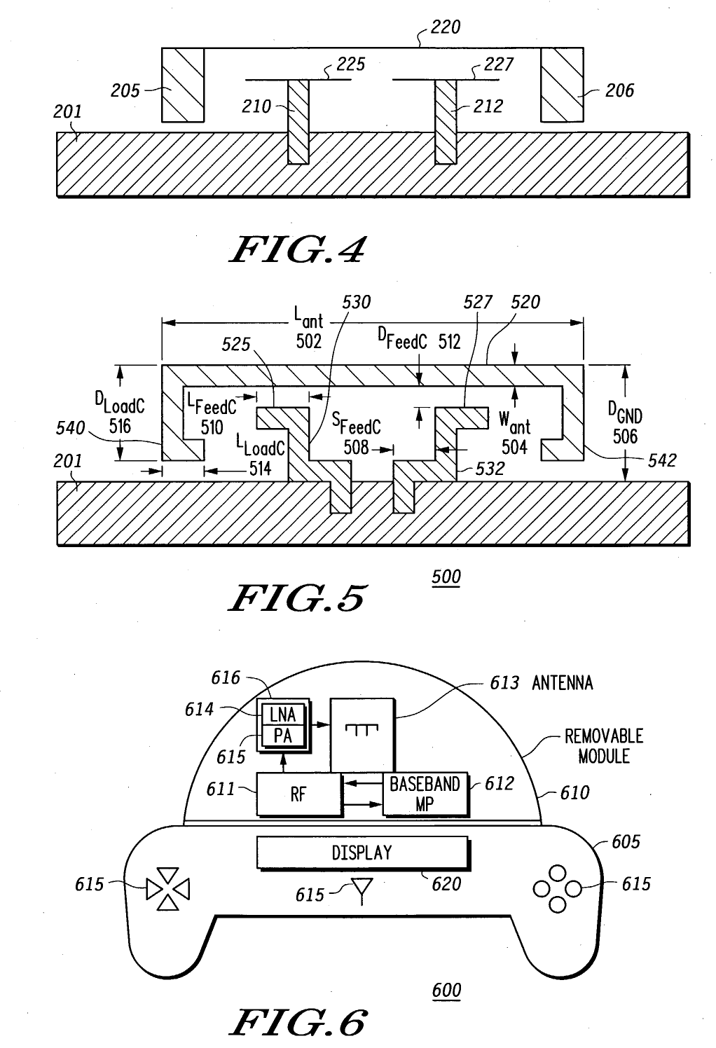

Referring to FIG. 4, a side view of the inverted C-type antenna of the embodiment of FIG. 3 is shown. The side view of FIG. 4 illustrates a planar balanced radiating element 220, where the capacitive loads 205 and 207 are each proximate to and capacitively coupled to ground plane 201. Also shown is the first and second capacitive feed elements 225 and 227 and the first and second transmission lines 210 and 212.

Referring to FIG. 5, another embodiment of an inverted C-type antenna 500 is shown. The particular embodiment of the inverted C-type antenna 500 is provided with various specific dimensions and geometries for a particular application. The illustrated inverted C-type antenna includes a substantially balanced radiating element 520, a first capacitive feed element 525, a second capacitive feed element 527, a first transmission line 530, and a second transmission line 532. The inverted C-type antenna 500 also includes a first capacitive load 540 and a second capacitive load 542. The first transmission line 530 and the second transmission line 532 are each coupled to the ground plane 201. The illustrated C-type antenna 500 was designed to operate and resonate at a frequency of about 2.45 GHz. Each of the dimensions illustrated in FIG. 5 for the particular example implementation is shown in the following table:

TABLE 1
Balanced antenna nominal dimensions

| | | Nominal |
|---|---|---|
| Variable | Description | Value |
| L_{ant 502} | Length of top segment | 28.0 |
| W_{ant 504} | Trace width of top segment | 1.0 |
| D_{gnd 506} | Distance of top segment from ground plane | 6.5 |
| S_{FeedC508} | Separation of feed capacitor from center axis | 3.5 |
| | of antenna | |
| L_{FeedC 510} | Length of feed capacitor | 5.0 |
| D_{FeedC 512} | Distance of feed capacitor segment from top | 1.5 |
| | segment | |
| L_{LoadC 514} | Length of load capacitor | 1.0 |
| D_{LoadC 516} | Distance of load capacitor segment from top | 4.875 |
| | segment | |

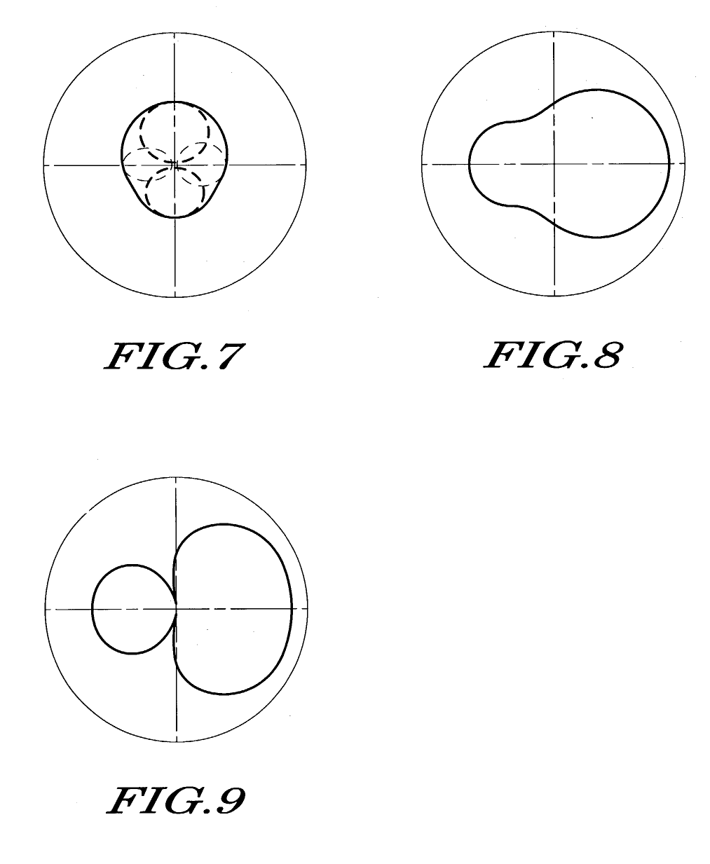

Referring to FIG. 6, a wireless handheld gaming device that utilizes an inverted C-type antenna is illustrated. The wireless gaming device 600 includes a housing portion 605 and a radio frequency (RF) module portion 610. The RF module 610 is separable from the housing body 605 of the gaming device 600. The RF module 610 includes a baseband microprocessor 612, an RF integrated circuit module 611, and the inverted C-type antenna 613. The RF module 611 is coupled to the inverted C-type antenna 613 via amplifying module 616 that includes a low noise amplifier (LNA) 614 for reception and a power amplifier (PA) 615 for transmission of RF signals. The antenna 613, the amplifying module 616, and the RF module 610 may be integrated onto a single printed circuit board.

The wireless gaming device 600 includes a display 620 and user interface elements such as directional input command buttons 615 and other user interface buttons. An example of such a device is the Game Boy device made by Nintendo. In certain applications, a first user with a first wireless gaming device desires to play games with a second user operating a second wireless gaming device. In this scenario, the first and second users may play a common game by having certain signals communicated between such devices via wireless signals. In such applications, a directional antenna may be used to provide for increased radiation coverage and reception capability along a horizontal plane that passes through the substantially planar shape of the wireless device. For the gaming device 600, the horizontal plane is in a direction that is parallel to the sheet of paper of FIG. 6. Any of the inverted C-type antennas disclosed herein may be configured to provide for the desired horizontal directional coverage.

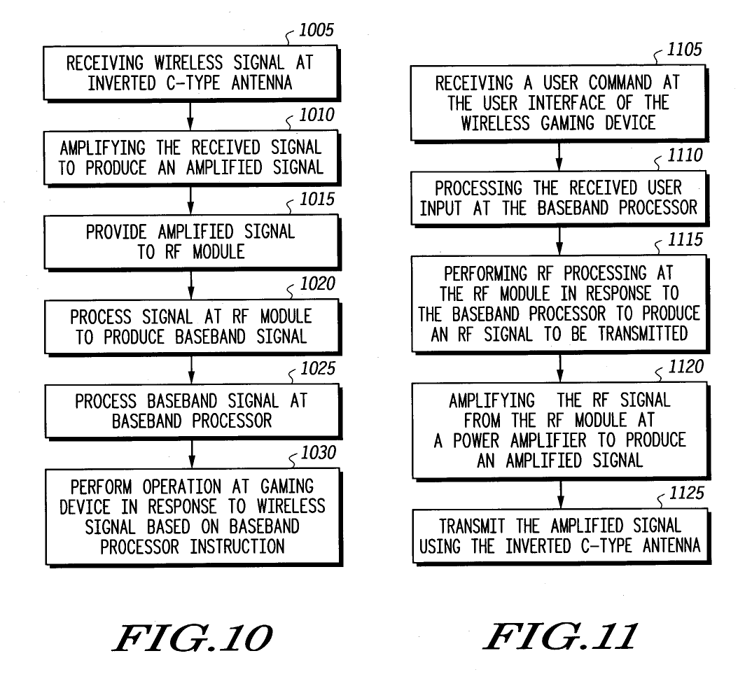

Referring to FIGS. 7 through 9, a sample radiation pattern of a particular embodiment of an inverted C-type antenna along different planes is illustrated. The radiation pattern shown in FIG. 7 is produced along the XY plane, the radiation pattern of FIG. 8 is along the YZ plane, and the antenna radiation pattern shown in FIG. 9 is along the ZX plane.

Referring to FIG. 10, a description of a method of operating a wireless device using an inverted C-type antenna is illustrated. A wireless signal is received at the inverted C-type antenna, at 1005. The received signal is amplified to produce an amplified signal, at 1010. The amplified signal is then provided to an RF module, such as an RF integrated circuit, at 1015. The amplified signal is then processed at the RF module to produce a baseband signal, at 1020. Such RF processing may include frequency signal downshifting and other traditional RF processing. The baseband signal is then processed by a baseband processor, such as a microprocessor, at 1025. A particular operation or various operations at the wireless gaming device may be in response to the received and processed wireless signal and the accompanying information derived by the baseband processor, at 1030. Thus, a signal such as from another gaming device may be communicated, received, detected, decoded and processed by the wireless gaming device in order to facilitate inter-device and coordinated processing.

Referring to FIG. 11, a method of processing and then transmitting a radio frequency signal using an inverted C-type antenna is illustrated. A user command, such as a user gaming input command is received at the user interface of the wireless gaming device, at 1105. The received user input signal is then processed at the base band processor, at 1110. RF processing is then performed at the RF module in response to direction of the base band processor to produce an RF signal that may be transmitted, at 1115. The RF signal is amplified at a power amplifier to produce an amplified signal suitable for transmission, at 1120. The amplified signal is then transmitted via the inverted C-type antenna, at 1125.

The disclosed antenna design provides a low cost low power reduced size antenna interface that is suitable for a variety of wireless applications. While a wireless gaming device application has been illustrated, it should be understood that the disclosed antenna structure is suitable for a wide of wireless applications, including other handheld devices and blue tooth capability. The disclosed antenna design provides an integrated design that is easy to manufacture and has the balanced design that reduces component count when interfaced to a balanced radio frequency integrated circuit.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An antenna comprising:
a radiating element, the radiating element being at least substantially balanced; and
a feed capacitor element capacitively coupled to the radiating element.

2. The antenna of claim 1, further comprising a load element coupled to the radiating element, the load element capacitively coupled to ground.

3. The antenna of claim 1, wherein the feed capacitor element includes a first feed capacitor element and a second feed capacitor element.

4. The antenna of claim 3, further comprising a first transmission line coupled to the first feed capacitor element and a second transmission line coupled to the second feed capacitor element.

5. The antenna of claim 4, wherein the first transmission line carries a first signal that is one hundred eighty degrees out of phase from a second signal carried by the second transmission line.

6. The antenna of claim 4, wherein the first transmission line is coupled at one end to ground and the second transmission line is coupled at one end to ground.

7. The antenna of claim 1, wherein the radiating element comprises a first segment and a second segment, the radiating element together with the first segment and the second segment forming an inverted C-type shape.

8. The antenna of clam 7, wherein the first segment is coupled to a first load element and the second segment is coupled to a second load element.

9. The antenna of claim 1, wherein the radiating element is less than thirty millimeters in length and the feed capacitor element has a length between two and fifteen millimeters.

10. The antenna of claim 1, wherein the feed capacitor element is disposed within two millimeters from the radiating element.

11. An antenna comprising:
a radiating element, the radiating element being at least substantially balanced;
a center connection coupling the radiating element to ground;
a first transmission line coupled to the radiating element and coupled to ground; and
a second transmission line coupled to the radiating element and coupled to ground.

12. The antenna of claim 11, wherein the radiating element comprises a first segment at one end and comprises a second segment at the other end.

13. The antenna of claim 12, further comprising a first capacitive load coupled to the first segment and a second capacitive load coupled to the second segment.

14. A wireless device comprising:
an inverted C-type antenna; and
a radio frequency module coupled to the inverted C-type antenna.

15. The wireless device of claim 14, wherein the inverted C-type antenna comprises a radiating element, a first feed capacitor element capacitively coupled to the radiating element and coupled to a first transmission line, and a second feed capacitor element coupled to a second transmission line and capacitively coupled to the radiating element, and wherein the inverted C-type antenna and the radio frequency module are integrated onto a printed circuit board.

16. The wireless device of claim 15, further comprising a baseband processor responsive to the radio frequency module, and wherein the inverted C-type antenna further comprises a load element coupled to the radiating element, the load element capacitively coupled to ground.

17. The wireless device of claim 15, wherein the first transmission line carries a first signal that is out of phase from a second signal carried by the second transmission line.

18. The wireless device of claim 17, wherein the first signal is between one hundred fifty degrees and two hundred ten degrees out of phase from the second signal.

19. The wireless device of claim 14, further comprising a substantially planar housing and wherein the inverted C-type antenna has a directional radiation pattern that provides coverage along a horizontal plane that traverses through the substantially planar housing.

20. A method of processing a wireless signal at a wireless device, the method comprising:
receiving the wireless signal at an inverted C-type antenna coupled to the wireless device.

21. The method of claim 20, further comprising amplifying the received wireless signal to produce an amplified signal, providing the amplified signal to a radio frequency module of the wireless device, and processing the amplified signal at the radio frequency module to produce a baseband signal.

22. The method of claim 21, further comprising providing the baseband signal to a baseband digital processor and processing the baseband signal at the baseband digital processor.

23. The method of claim 22, further comprising receiving user input at a user interface of the wireless device.

24. The method of claim 23, further comprising processing a command indicated by the user input at the baseband processor.

25. The method of claim 24, further comprising processing a signal received from the baseband processor at the radio frequency module to produce a radio frequency signal.

26. The method of claim 25, further comprising amplifying the radio frequency signal to produce a second amplified signal.

27. The method of claim 26, further comprising transmitting the second amplified signal using the inverted C-type antenna.

28. The method of claim 23, wherein the user interface includes a plurality of gaming input elements.

29. The method of claim 20, wherein receiving the wireless signal at the inverted C-type antenna comprises receiving the wireless signal at a radiating element, the radiating element being at least substantially balanced, the inverted C-type antenna further comprising a first feed capacitor element and a second feed capacitor element, the first feed capacitor element coupled to a first transmission line and capacitively coupled to the radiating element, the second feed capacitor element coupled to a second transmission line and capacitively coupled to the radiating element.
